(19) United States
(12) Patent Application Publication
(10) Pub. No.: US 2005/0151304 A1
(43) Pub. Date: Jul. 14, 2005

(54) Method of trimming a balloon of a balloon catheter

(75) Inventors: Johan Boelens, Hechingen (DE); Volker Troesken, Bochum (DE)

Correspondence Address: SHINJYU GLOBAL IP COUNSELORS, LLP, 1233 20TH STREET, NW, SUITE 700, WASHINGTON, DC, 20036-2680, US

(73) Assignee: Abbott Laboratories Vascular Enterprises Limited, Dublin (IE)

(21) Appl. No.: 10/753,061

(22) Filed: Jan. 8, 2004

(51) Int. Cl. B28B 1/00

(52) U.S. Cl. 264/632; 606/194; 264/103

(57) ABSTRACT

A method of trimming a balloon of a balloon catheter is provided that includes creating protrusions on the balloon by wrapping a member around the balloon, leaving the member wrapped around the balloon and removing the member from the balloon. The member is wrapped around the balloon such that spaced-apart loops of the member wrapped around the balloon compress the balloon leaving uncompressed portions of the balloon between the spaced apart loops of the member wrapped around the balloon to form the protrusions on the balloon. The member wrapped around the balloon is left for a predetermined period of time. The member is removed from the balloon after the predetermined period of time. A balloon catheter is also provided that is constructed in accordance with this method.

### BACKGROUND OF THE INVENTION

1. Field of the Invention

The present invention concerns a method of trimming a balloon of a balloon catheter. The present invention also concerns a balloon catheter constructed in accordance with this method.

2. Background Information

Balloon catheters are used for recanalisation of blocked or narrowed blood vessels. For this purpose, a known balloon catheter comprises an expandable balloon. The balloon is folded and a stent may be crimped onto the folded balloon for introducing the balloon catheter and the stent crimped thereon into the body vessel.

Known balloon catheters, however, often cause problems in particular in case of extremely narrow vessels as the balloon of known balloon catheters often cannot sufficiently hold the crimped-upon stent while being moved through the vessels.

In view of the above, it will be apparent to those skilled in the art from this disclosure that there exists a need for an improved method of trimming a balloon of a balloon catheter. This invention addresses this need in the art as well as other needs, which will become apparent to those skilled in the art from this disclosure.

### SUMMARY OF THE INVENTION

U.S. Pat. No. 5,066,298 discloses a pre-compressed angioplasty balloon catheter having a balloon portion being wrapped for storage and for minimizing its outside diameter for purpose of insertion into the body. The balloon portion of said catheter is tightly wrapped in its collapsed condition with a tape. As, however, the tape is wrapped in conventional overlapping fashion the only effect of said tape is minimizing the outer balloon diameter. There is absolutely no effect with respect to an improvement of the fastening characteristics for holding a stent crimped onto said balloon.

Therefore, it is an object of the present invention to provide a method of trimming a balloon of a balloon catheter that makes it possible to produce a balloon that provides for improved stent fastening characteristics.

By wrapping a thread or flat band (i.e., a member) around a folded balloon and leaving that thread (member) on the folded balloon for a predetermined period of time, it is possible to compress spaced-apart portions of the folds tightly together, which results, as a side-effect, in an extremely small profile of the balloon in its folded condition, and in a rough surface of the folded balloon resulting in a higher surface friction. This, in turn, results in the advantage that the stent crimped onto the folded balloon can temporarily be fixed much easier on the balloon, thus preventing the stent from slipping from the balloon when being moved within a body vessel.

For a pre-mounted system (balloon and stent), the use of a round, flat or otherwise shaped thread (i.e., member) is preferable.

Moreover, the method according to the present invention results in a balloon that can be easily pushed forward through extremely curved vessels without causing the problem that the folds open when the balloon moves through such extreme curves.

Moreover, also the conical end portions of the balloon, which are stiffer or harder than the central portion of the balloon, can be compressed more easily with the method according to the present invention.

The folded balloon can be somewhat heated when the thread (member) is wrapped around the folded balloon, thus increasing or accelerating the effect of the higher compression and enhancing formation of the surface structure of the balloon.

Preferred materials of the thread (member) are polytetrafluorethylene or polyurethane. Moreover, it will be apparent to those skilled in the art from this disclosure that any other material is possible and any shape of thread profile or band profile (member) can be used as needed and/or desired.

The method according to the present invention can be effected manually or automatically by a suitable machine.

The dependent claims contain advantageous embodiments of the method according to claim 1.

The foregoing objects can basically be achieved by achieved by providing a method of trimming a balloon of a balloon catheter that includes creating protrusions on the balloon by wrapping a member around the balloon, leaving the member wrapped around the balloon and removing the member from the balloon. The member is wrapped around the balloon such that spaced-apart loops of the member wrapped around the balloon compress the balloon leaving uncompressed portions of the balloon between the spaced apart loops of the member wrapped around the balloon to form the protrusions on the balloon. The member wrapped around the balloon is left for a predetermined period of time. The member is removed from the balloon after the predetermined period of time.

The foregoing objects can further be attained by a balloon catheter that is produced according to the principles of the method according to the present invention.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows a balloon of a balloon catheter along with a tape or thread (i.e., a member) wrapped around the balloon for explaining the features of the method according to the present invention,

FIG. 2 shows the balloon of a balloon catheter illustrated in FIG. 1, after having removed the thread or band (member), and

FIG. 3 shows the balloon of a balloon catheter illustrated in FIG. 2, with a stent being crimped thereon.

### DETAILED DESCRIPTION OF THE PREFERRED EMBODIMENTS

A selected embodiment of the present invention will now be explained with reference to the drawings. It will be apparent to those skilled in the art from this disclosure that the following descriptions of the embodiment of the present invention are provided for illustration only and not for the purpose of limiting the invention as defined by the appended claims and their equivalents.

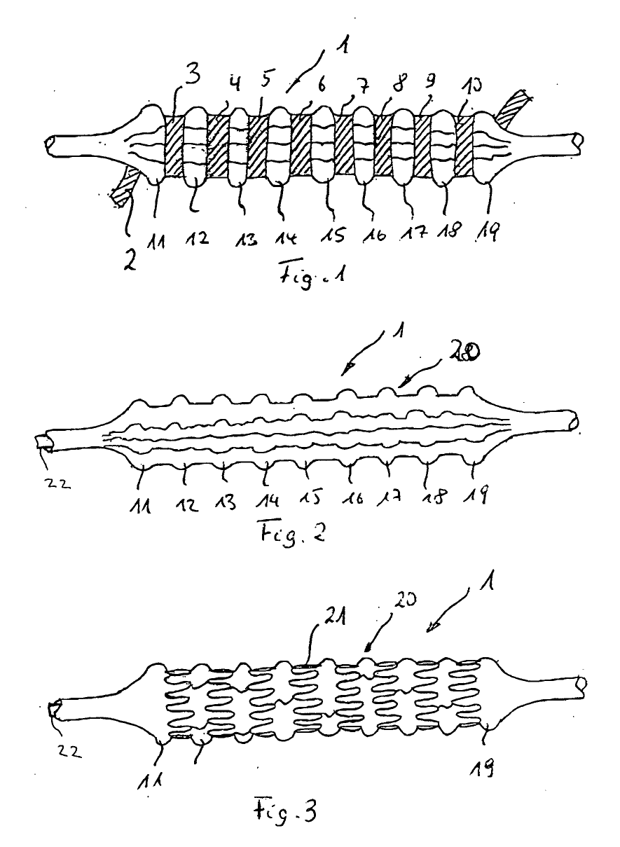

Referring initially to FIG. 1, a balloon 1 of a balloon catheter is shown. According to the present invention, the balloon 1 can be formed and folded in a conventional manner. Specifically, the balloon 1 is preferably formed by introducing a tube of balloon material into a balloon forming mold, forming the tube of balloon material into a balloon shape (i.e, uncompressed state), and taking the balloon out of the mold.

After having folded the balloon 1, a flat band (i.e., a member) 2, as shown in FIG. 1, (or alternatively a thread) is wrapped around the balloon 1 such that spaced-apart loops 3-10 are created. Needless to say that also a different number of loops can be formed.

As is apparent from FIG. 1 the band 2 is wrapped around the balloon 1 such that loops 3-10 leave ring-like protrusions 11-17 between two respective loops (e.g. 3, 4 and 5, 6 and so on).

The band 2 is left on the balloon for a predetermined period of time. It will be apparent to those skilled in the art from this disclosure that the predetermined period of time can be any period of time suitable to form the balloon 1 shown in FIG. 2.

FIG. 2 shows balloon 1 with the band 2 being removed. Balloon 1 now comprises a surface structure 20 that has improved fastening characteristics as the surface structure 20 provides for a high friction so that a stent crimped on the balloon 1 can be held more securely. The balloon 1 can be attached to a catheter tube 22 in a conventional manner.

Such a state of balloon 1 is shown in FIG. 3 where a stent 21 is employed on surface structure 20. FIG. 3 shows that protrusions 11-19 secure the stent 21 securely on the balloon 1. The protrusions 11-19 extend through the apertures in the stent structure such that the stent 21 can be prevented from slipping off the balloon 1 while being moved, even through a curved body vessel or a narrow stenosis.

While only a selected embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents. Thus, the scope of the invention is not limited to the disclosed embodiments.

1. A method of trimming a balloon of a balloon catheter, the method comprising:
creating protrusions on the balloon by wrapping a member around the balloon such that spaced-apart loops of the member wrapped around the balloon compress the balloon leaving uncompressed portions of the balloon between the spaced apart loops of the member wrapped around the balloon to form the protrusions on the balloon;
leaving the member wrapped around the balloon for a predetermined period of time; and
removing the member from the balloon after the predetermined period of time.

2. The method according to claim 1, further comprising
heating the balloon during at least one of the creating protrusions on the balloon by wrapping the member around the balloon and the leaving the member wrapped around the balloon for the predetermined period of time.

3. The method according to claim 2, wherein
the member wrapped around the balloon is constructed of one of polytetrafluorethylene and polyurethane.

4. The method according to claim 3, further comprising
folding the balloon prior to the creating protrusions on the balloon by wrapping the member around the balloon.

5. The method according to claim 4, further comprising the following steps prior to the creating protrusions on the balloon by wrapping the member around the balloon:
introducing a tube of balloon material into a balloon forming mold;
forming the tube of balloon material into a balloon shape; and
taking the balloon out of the mold.

6. The method according to claim 5, further comprising
attaching the balloon to a catheter tubing.

7. The method according to claim 6, wherein
the folding of the balloon, the creating protrusions on the balloon by wrapping the member around the balloon and the removing the member from the balloon after the predetermined period of time are achieved manually.

8. The method according to claim 6, wherein
the folding of the balloon, the creating protrusions on the balloon by wrapping the member around the balloon and the removing the member from the balloon after the predetermined period of time are achieved by a machine.

9. The method according to claim 1, wherein
the member wrapped around the balloon is constructed of one of polytetrafluorethylene and polyurethane.

10. The method according to claim 1, further comprising
folding the balloon prior to the creating protrusions on the balloon by wrapping the member around the balloon.

11. The method according to claim 10, further comprising the following steps prior to the creating protrusions on the balloon by wrapping the member around the balloon:
introducing a tube of balloon material into a balloon forming mold;
forming the tube of balloon material into a balloon shape; and
taking the balloon out of the mold.

12. The method according to claim 11, further comprising
attaching the balloon to a catheter tubing.

13. The method according to claim 12, wherein
the folding of the balloon, the creating protrusions on the balloon by wrapping the member around the balloon and the removing the member from the balloon after the predetermined period of time are achieved manually.

14. The method according to claim 12, wherein
the folding of the balloon, the creating protrusions on the balloon by wrapping the member around the balloon and the removing the member from the balloon after the predetermined period of time are achieved by a machine.

15. The method according to claim 1, further comprising the following steps prior to the creating protrusions on the balloon by wrapping the member around the balloon:
introducing a tube of balloon material into a balloon forming mold;
forming the tube of balloon material into a balloon shape; and
taking the balloon out of the mold.

16. The method according to claim 1, further comprising
attaching the balloon to a catheter tubing.

17. The method according to claim 1, wherein
the creating protrusions on the balloon by wrapping the member around the balloon and the removing the member from the balloon after the predetermined period of time are achieved manually.

18. The method according to claim 1, wherein
the creating protrusions on the balloon by wrapping the member around the balloon and the removing the member from the balloon after the predetermined period of time are achieved by a machine.

19. A balloon catheter comprising:
a foldable and expandable balloon having protrusions on the balloon, the protrusions being created by
wrapping a member around the balloon such that spaced-apart loops of the member wrapped around the balloon compress the balloon leaving uncompressed portions of the balloon between the spaced apart loops of the member wrapped around the balloon to form the protrusions on the balloon;
leaving the member wrapped around the balloon for a predetermined period of time; and
removing the member from the balloon after the predetermined period of time.

20. The balloon catheter according to claim 19, wherein
the balloon is heated during at least one of the wrapping the member around the balloon and the leaving the member wrapped around the balloon for the predetermined period of time.
